(19) United States
(12) Patent Application Publication
(10) Pub. No.: US 2003/0230531 A1
(43) Pub. Date: Dec. 18, 2003

(54) Method for reducing boron concentration in high salinity liquid

(75) Inventors: Mark Wilf, San Diego, CA (US); Craig R. Bartels, San Diego, CA (US); Masahiko Hirose, Ritto (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Hydranautics and Nitto Denko Corporation

(21) Appl. No.: 10/188,476

(22) Filed: Jul. 3, 2002

Related U.S. Application Data
(60) Provisional application No. 60/388,256, filed on Jun. 13, 2002.

(51) Int. Cl. B01D 61/10

(52) U.S. Cl. 210/639; 210/641; 210/652; 210/696

(57) ABSTRACT

A method of treating a high salinity liquid, such as seawater, containing boron is provided. The method includes adjusting the pH of the liquid to about 8.5 to about 9.5, optionally adding a scale inhibitor to the liquid, passing the liquid through a reverse osmosis device, and recovering a permeate having a boron concentration less than about 1 ppm.

### CROSS-REFERENCE TO RELATED APPLICATIONS

This application claims the benefit of the U.S. Provisional Application of Mark Wilf et al. entitled “Method for Reducing Boron Concentration in High Salinity Liquid”, filed Jun. 12, 2002.

### BACKGROUND OF THE INVENTION

Seawater typically contains about 4 to 7 ppm boron, in addition to a variety of water-soluble salts. Traditional methods for purifying (desalinating) seawater for drinking and irrigation purposes utilize reverse osmosis (RO) membranes, which are effective at significantly reducing the concentrations of all dissolved ions in the seawater. Although the reduction of the majority of dissolved ions by polyamide reverse osmosis membranes is about 98% to about 99%, the rejection rate of boron by these membranes is much lower, typically in the 70%-90% range, and may be even lower at high feed water temperatures (greater than about 25° C.).

The significantly lower rejection rate of boron by polyamide membranes may be explained by the very low dissociation rate of boric species at neutral pH. However, this boric species dissociation rate increases with pH and reaches 50% dissociation at a pH of 8.6 to 9.8, depending on the ionic strength of the solution and the temperature (W. Stumm, et al. Aquatic Chemistry, John Wiley & Sons (1981)). Consequently, an increased boron rejection rate is achievable at high pH, thus making possible appreciable boron concentration reduction by reverse osmosis.

Magara, et al. (Desalination 118:25-34 (1998)) and Prats, et al. (Desalination 128: 269-273 (2000)) describe methods for reducing boron concentration using two-pass reverse osmosis systems. In these systems, the pH of the permeate from the first pass is increased before it is passed through the RO membrane in the second pass in order to improve the boron rejection. The term “permeate” is known in the art to refer to reverse osmosis product water. Because the RO permeate from these systems has low salinity, even adjustment of the pH to high levels does not result in scale formation.

An example of a similar methodology applied to high salinity water is described by Tao, et al. (U.S. Pat. No. 5,250,185), which describes the application of a high pH RO processing method to oilfield-produced water. In order to prevent scaling of the reverse osmosis system by carbonate salts, the feed water is softened prior to adjustment of the pH to a level greater than 9.5. Tao teaches that the high pH is necessary to obtain the desired increase in boron rejection. Additionally, Mukhopadhyay (U.S. Pat. No. 5,925,255) describes the treatment of brackish and low salinity water by reverse osmosis, in which the hardness of the RO feed water is removed by a weak acid cation exchange resin.

It would be desirable to be able to significantly reduce the concentration of boron in high salinity liquids in a straightforward, one-pass process that would be attractive due to the lower operating costs relative to two-pass methods.

### SUMMARY OF THE INVENTION

According to the present invention, a method for reducing boron concentration in a high-salinity liquid which meets the above objectives is provided. The method comprises adjusting the pH of the liquid to about 8.5 to about 9.5, passing the liquid through a reverse osmosis device, and recovering a permeate having a boron concentration of less than about 1 ppm.

### DETAILED DESCRIPTION OF THE INVENTION

The present invention is directed to a method for reducing the concentration of boron in high-salinity boron-containing liquids such as seawater, in which the resulting treated water, or permeate, has a substantially decreased boron concentration. The method comprises adjusting the pH of the high salinity liquid to an appropriate high level, passing the high salinity liquid through a reverse osmosis device, and recovering a permeate having a reduced boron concentration of less than about 1 ppm of boron. In a preferred embodiment, the permeate has a reduced boron concentration of less than about 0.5 ppm.

The term “high salinity liquid” may be understood to mean any liquid having a salt content of at least about 2000 ppm of total dissolved salts (TDS), and more preferably greater than about 10,000 ppm TDS. In one embodiment, the high salinity boron-containing liquid is seawater, but any high salinity liquid which contains boron may be treated by the method of the invention. The presently preferred method of measuring the boron concentration is ICAP (Ion Coupled Argon Plasma). However, boron determination may be accomplished by any standard technique know to those in the art.

It is preferred to adjust the pH of the high salinity liquid to about 8.5 to about 9.5, and more preferably to about 8.5 to about 9.3. As previously described, literature reports have shown that boron rejection can be greatly enhanced by raising the pH to high levels, such as greater than 9.5. However, under such conditions, softening of the water is also necessary. Because high pH levels may result in calcium scaling, typical RO plants are operated at pH levels of 8.2 or less to ensure the absence of calcium scale formation. In contrast, the method according to the present invention is advantageous because it does not require pre-softening of the water and results in substantially higher boron rejection by operating the reverse osmosis system at pH levels of about 8.5 to about 9.5, slightly higher than normal.

According to the present invention, the pH is preferably adjusted by treating the high salinity liquid with a base such as the preferred sodium hydroxide or calcium hydroxide. Other common bases, such as lime (calcium oxide), may also be used. Even if the pH of the high salinity liquid is initially greater than 8.5, it may be desirable for some applications to raise the pH to the upper end of the desired range: closer to about 9.5.

In a preferred embodiment, both the measurement and adjustment of the pH are performed in-line while the high salinity liquid flows. Following determination of the pH, a dosing pump which is fed from a tank injects the base into the in-line fluid. Ideally, the dosing pump has automatic feedback which automatically monitors and controls the amount of base which is added. No mixing is required because the base is mixed naturally with the high salinity liquid as it flows.

Following adjustment of the pH of the high salinity liquid, the liquid is passed through a reverse osmosis device which is preferably a pressure vessel. In one embodiment, the reverse osmosis device comprises an array or set of filter elements arranged in a series and parallel configuration to achieve a given water removal requirement. The array contains reverse osmosis membrane elements which are preferably polyamide type membranes having slight or excessive negatively charged surface. Other negatively charged separation membranes, such as polyacrylic acid, may also be used. The membrane elements may be arranged in a variety of packing configurations such as a plate and frame module, or a hollow fiber module, and more preferably a spiral wound configuration. Typical spiral wound reverse osmosis membrane elements which are commercially available are 4″×40″ or 8″×40″, but any membrane configuration or dimension known in the art would be applicable for the method of the invention. Typically, pressure devices comprise about 6 to about 8 membrane elements, but under some circumstances, it may be desirable to use fewer membranes in the pressure device.

The liquid may be passed through the RO device at ambient temperature or at slightly reduced or slightly elevated temperatures. More particularly, the method would be effective at normal temperature range for the membranes of about 110° C. to about 45° C. It is not believed that the effect of pH on boron removal is significantly affected by changes in temperature. However, while the method may be performed at temperatures below about 20° C., RO membranes are inherently more effective at rejecting boron at these lower temperatures and the pH adjustment step may not be needed. The method may be performed at normal operating pressures of a reverse osmosis membrane such as about 800 to about 1500 psi, more preferably about 800 to about 1200 psi, and most preferably about 900 to about 1000 psi. In an exemplary method, saline water is provided at about 12 to about 75 gpm for an 8 inch diameter by 40 inch long element.

In one embodiment, the method further comprises adding a scale inhibitor to the high salinity liquid before passing the water through the RO device in order to prevent the formation of carbonate or other hardness scales in the membranes, which typically occurs at high pH. The anti-scalant may be any commercial scale inhibitor known in the art to control calcium carbonate scaling or magnesium hydroxide scaling. A preferred dosage of scale inhibitor is about 0.5 to about 5 ppm. However, there is a limit to the effectiveness of scale inhibitors. In particular, if the pH is greater than about 9.5, it is likely that an anti-scalant may not be able to delay or inhibit scale formation. In the present method, the pH is controlled to be about 8.5 to about 9.5, and thus no scale formation occurs when a scale inhibitor is added.

After the liquid is passed through the first pass RO device, the permeate that is recovered has a reduced boron concentration of less than about 1 ppm, and more preferably less than about 0.5 ppm. The permeate also has reduced concentrations of all soluble salt ions, such as sodium, magnesium, chloride. The permeate from the first pass membrane elements, which is low in boron, may be used as is, or may be treated further by an additional membrane process, such as membrane, ion exchange, distillation or other boron reducing process to further lower the boron concentration. Because the feed water for the second pass RO system has lower salinity, the second pass system can be operated at lower pressures and use less energy. In other words, the size of the second treatment system may be minimized by operating the first pass of membrane elements at the high end of the pH range to produce a lower boron permeate. The reduction in the size of the second pass RO system thus results in cost savings.

This invention will best be understood in connection with the following, non-limiting examples.

### EXAMPLE 1

A typical 8 inch pressure vessel was loaded with eight SWC3 spiral wound membrane elements, commercially available from Hydranautics, in series. The combined permeate from all eight elements could be collected from a common exit port from the pressure vessel. A sample of seawater was tested and found to have a pH of 8.14. Using ICAP (Ion Coupled Argon Plasma), the boron concentration of the seawater was determined to be 6.02 ppm. The seawater, at a temperature of 23.1° C., was introduced into the pressure vessel at a feed pressure of 1140 psi. The pressure vessel operated at a recovery rate of 50%. After passing through the pressure vessel, the permeate was analyzed and found to have a boron concentration of 1.27 ppm.

### EXAMPLE 2

A second sample of seawater having a boron concentration of 5.89 ppm was treated with sodium hydroxide in-line to raise the pH to 9.24. Approximately 28 ppm of 100% NaOH were added to achieve a pH in the desired range. Approximately 4 ppm of a commercial anti-sealant was added to the liquid. The seawater, at a temperature of 23.4° C., was fed through the same pressure vessel as in EXAMPLE 1. After passing through the pressure vessel, the permeate was analyzed and found to have a boron concentration of 0.48 ppm. The data from the two Examples are tabulated below.

| | | | Initial boron | Final boron |
|---|---|---|---|---|
| Example | Water Temp (° C.) | Water pH | concentration (ppm) | concentration (ppm) |
| 1 | 23.1 | 8.14 | 6.02 | 1.27 |
| 2 | 23.4 | 9.24 | 5.89 | 0.48 |

These Examples demonstrate that the pH of the high salinity liquid has a significant effect on the final boron concentration in the permeate recovered from the reverse osmosis device. When the pH is about 8.5 to about 9.5, the boron concentration may be reduced to less than about 0.5 ppm.

In comparison with other methods known in the art for reducing boron concentration using reverse osmosis membranes, the present method has the advantage of offering a significantly increased boron rejection rate in a seawater reverse osmosis membrane system using a single pass configuration. This decrease in boron concentration is accomplished at an elevated pH which is low enough that in the presence of a scale inhibitor, no scale formation is observed.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of reducing a boron concentration in a high-salinity boron-containing liquid comprising:
(a) adjusting a pH of the high salinity liquid to about 8.5 to about 9.5;
(b) passing the high-salinity liquid through a reverse osmosis device; and
(c) recovering a permeate from the reverse osmosis device wherein the permeate comprises a boron concentration of less than about 1 ppm.

2. The method of claim 1, wherein the high salinity liquid is seawater.

3. The method of claim 2, wherein the seawater comprises about 4 to about 7 ppm of boron.

4. The method of claim 1, wherein the pH of the high salinity liquid is adjusted to about 8.5 to about 9.3.

5. The method of claim 1, wherein step (a) comprises adding a base to the high salinity liquid.

6. The method of claim 5, wherein the base is selected from the group consisting of calcium hydroxide, sodium hydroxide and lime.

7. The method of claim 1, wherein the reverse osmosis device comprises an array comprising at least one reverse osmosis membrane.

8. The method of claim 7, wherein the at least one reverse osmosis membrane is a polyamide-type membrane.

9. The method of claim 7, wherein the at least one reverse osmosis membrane is selected from the group consisting of a spiral wound membrane and a hollow fiber membrane.

10. The method of claim 1, further comprising adding a scale inhibitor to the high salinity liquid before step (b).

11. The method of claim 1, wherein the permeate comprises a boron concentration of less than about 0.5 ppm.

12. The method of claim 1, further comprising (d) passing the permeate of step (c) through a further reverse osmosis device to further reduce the boron concentration.
